(19) United States
(12) Patent Application Publication
(10) Pub. No.: US 2026/0199810 A1
(43) Pub. Date: Jul. 16, 2026

(54) METHODS FOR FOAM MITIGATION USING ANTI-FOAM AND DE-FOAMING COMPOSITIONS

(71) Applicant: ECOLAB USA Inc., St. Paul, MN (US)

(72) Inventors: Ashish DHAWAN, Aurora, IL (US); Julianne TRUFFA, New Lenox, IL (US); Carter Martin SILVERNAIL, Lakeville, MN (US)

(73) Assignee: ECOLAB USA Inc., St. Paul, MN (US)

(21) Appl. No.: 19/443,483

(22) Filed: Jan. 8, 2026

Related U.S. Application Data
(60) Provisional application No. 63/743,860, filed on Jan. 10, 2025.

(51) Int. Cl. B01D 19/04

(52) U.S. Cl. CPC B01D 19/0495

(57) ABSTRACT

The present disclosure relates to methods and compositions for controlling foam. The method includes adding an effective amount of a composition to an industrial medium. The composition includes an effective amount of a reaction product of an alkenyl succinic anhydride and an amino-hydroxy compound. The methods and compositions may be used in, for example, pulp and paper processing water, wastewater, a laundry detergent, a warewashing detergent, fermentation products, food processing water, petroleum gas scrubbing process water, cleansing or disinfecting water, metal treatment products, polymers, chemical synthesis byproducts, and any combination thereof.

### TECHNICAL FIELD

The present disclosure generally relates to compositions and methods for mitigating foam in an aqueous medium.

### BACKGROUND

Defoamers with high hydrophobicity and very low surface tension perform well. They find primary use in suppressing foam production across various applications, including laundry detergents, pulp and paper (particulate stabilized foams), mineral processing, food processing (proteinous foams), agrochemicals, and oilfield processes.

However, silicon-based anti-foaming agents based on polydimethylsiloxane come with several challenges, including deposition risk, carryover, emulsification, dosage control, injection issues, robustness, and scaling. These agents are also less compatible with most surfactant systems, such as wetting agents or liquid cleaning compositions, and tend to precipitate. Moreover, there are instances where their use could be prohibitive, especially in petroleum refining, where the presence of silicone antifoams may lead to catalyst poisoning or product contamination, particularly in fuels. As a result, the industry seeks more effective defoamer chemistries to address these concerns.

Defoaming agents should lower the surface tension allowing the defoamer to spread rapidly to achieve interaction with foam for penetrating the foam's lamellae to allow the entrapped gas to escape and the foam to burst. Also, a defoaming agent should find a delicate equilibrium between being soluble and insoluble. If a defoaming agent is too dispersible or soluble, it won't effectively combat foam and might even aggravate foam buildup. Conversely, if a defoaming agent is insufficiently dispersible or too insoluble within the system, it can cling to equipment surfaces, leading to defects and other operational challenges. Therefore, it is necessary to provide defoamers and antifoaming compositions with an appropriate hydrophobicity and hydrophilicity balance.

### BRIEF SUMMARY

In some embodiments, the present disclosure provides methods of controlling foam in an industrial medium. The methods may comprise adding an effective amount of a composition to the industrial medium, the composition comprising a reaction product of a succinic anhydride and an amino-hydroxy compound.

In some embodiments, the succinic anhydride comprises an alkenyl succinic anhydride (ASA). In some embodiments, the succinic anhydride is selected from the group consisting of octenyl succinic anhydride, dodecenyl succinic anhydride, undecenyl succinic anhydride, hexadecenyl succinic anhydride, octadecenyl succinic anhydride, and any combination thereof.

In some embodiments, the amino-hydroxy compound comprises an acyclic aliphatic compound, a cyclic aliphatic compound, an aromatic compound, or any combination thereof. In some embodiments, the amino-hydroxy compound is selected from the group consisting of 1-(aminomethyl)cyclopentanol, 4-aminocyclohexanol, 2-aminocyclohexanol, 2-aminoethanol, 3-aminopropanol, 4-aminobutanol, 2-aminobutanol, 5-aminopentanol, 1-amino-2-propanol, 2-((2-hydroxyethyl)amino) ethanol, 2-aminopropane-1,3-diol, 2-(2-aminoethylamino) ethanol, 2-(2-aminoethoxy) ethanol, 2-amino-2-(hydroxymethyl) propane-1,3-diol, 2-((3-aminopropyl)amino) ethanol, and any combination thereof.

In some embodiments, the reaction product comprises a succinimide. In some embodiments, the reaction product comprises a structure of Formula I:

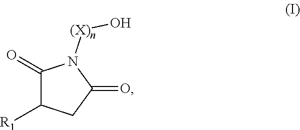

wherein X, R₁, and n are as described herein.

In some embodiments, the reaction product comprises a structure of Formula II:

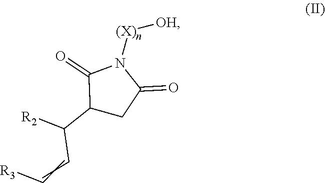

wherein X, R₂, R₃, and n are as described herein.

In some embodiments, the reaction product comprises a structure of Formula III:

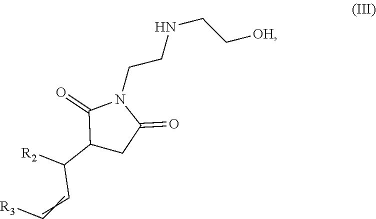

wherein R₂ and R₃ are as described herein.

In some embodiments, the composition excludes a silicon-containing compound, an anhydride-containing compound, an amide-containing compound, a carboxylate-containing compound, and any combination thereof.

In some embodiments, the method excludes adding a silicon-containing compound, an anhydride-containing compound, an amide-containing compound, a carboxylate-containing compound, and any combination thereof, to the industrial medium.

In some embodiments, the industrial medium comprises water and/or a brine. In some embodiments, the industrial medium comprises a surfactant. In some embodiments, the industrial medium comprises a black liquor. In some embodiments, the industrial medium comprises pulp and paper processing water, wastewater, a laundry detergent, a warewashing detergent, fermentation products, food processing water, petroleum gas scrubbing process water, cleansing or disinfecting water, metal treatment products, polymers, chemical synthesis byproducts, and any combination thereof.

In some embodiments, the effective amount is selected from about 0.001 wt. % to about 5 wt. %. In some embodiments, the composition comprises from about 0.001 wt. % to about 5 wt. % of the reaction product.

The present disclosure also provides compositions comprising an industrial medium and a reaction product of a succinic anhydride and an amino-hydroxy compound.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### BRIEF DESCRIPTION OF THE SEVERAL VIEWS OF THE DRAWINGS

A detailed description of the invention is hereafter described with specific reference being made to the drawings in which:

FIG. 1 shows the antifoam performance of anti-foam agents in tap water at concentrations relative to a foaming surfactant;

FIG. 2 shows the antifoam performance of anti-foam agents in a 3% NaCl solution at concentrations relative to a foaming surfactant;

FIG. 3 shows the antifoam performance of anti-foam agents in a 5% black liquor solution at the indicated concentrations;

FIG. 4 shows the surface tension as a function of surface lifetime at various concentrations of a C₁₂ASA-2-(2-aminoethylamino) ethanol (2AEAE) in water;

FIG. 5 shows the surface tension as a function of surface lifetime at various concentrations of a C₁₈ASA-2AEAE in water; and

FIG. 6 shows the quasi-static surface tension as a function of concentration of a C₁₂ASA-2AEAE and a C₁₈ASA-2AEAE, used in order to approximate the critical micelle concentration.

### DETAILED DESCRIPTION

The present disclosure provides compositions and methods for controlling foam in an industrial medium. The term “controlling” used herein is intended to encompass actions like reducing, abating, preventing, inhibiting, slowing, etc. Compositions comprising anti-foam compounds are disclosed herein and may be used in methods for controlling foaming. When the present disclosure refers to an “anti-foam compound,” it is to be understood that this term covers a single anti-foam compound and in certain instances, the term covers multiple anti-foam compounds. For example, in some embodiments, a composition of the present disclosure may include a solvent and an anti-foam compound. The anti-foam compound may comprise the reaction product of a succinic anhydride and an amino-hydroxy compound alone, in some embodiments, but in other embodiments, the anti-foam compound may comprise the reaction product of a succinic anhydride and an amino-hydroxy compound, and optionally an additional anti-foam compound, an emulsifying surfactant, a solvent, and any combination thereof.

While “anti-foam” compounds may be said to prevent foaming and “de-foaming” compounds may be said to reduce foaming, the presently disclosed term “anti-foam” compound may be used to cover both “anti-foam” compounds as well as “de-foaming” compounds. In some embodiments, however, the term may be used to cover only “anti-foam” compounds or “de-foaming” compounds, and such embodiments will be explicitly indicated as such. In certain embodiments, the term “anti-foam” compound covers any compound that prevents or reduces foaming.

The term “surface tension (o)” refers to the work which must be used to increase the size of the interface of a gas and a liquid, such as between air and water. The surface tension of a surfactant-free fluid is independent from the age of the surface, whereas fluids containing surfactants depend on the age of the surface. If a new surface is created within a surfactant solution, it is free of surfactants from the moment of its creation. A concentration gradient exists between the surfactants dissolved in the fluid and the nearly surfactant-free surface. Therefore, the surfactants diffuse at the surface and replace the fluid's molecules. This will cause the surface tension to change with time/age. Diffusion and orientation of the surfactant molecules takes time, which depends on the mobility of the surfactants in the solution.

The term “black liquor” refers to an industrial medium comprising by-products from the kraft process when digesting pulpwood into paper pulp removing lignin, hemicelluloses and other extractives from the wood to free the cellulose fibers.

The terms “C_{x-y}” or “Cₓ-C_{y}”, when used in conjunction with a chemical moiety, such as, acyl, acyloxy, alkyl, alkenyl, alkynyl, or alkoxy are meant to include groups that contain from x to y carbons in the chain. C₀ alkyl indicates a hydrogen where the group is in a terminal position or a bond if internal. A C₁₋₆ alkyl group, for example, contains from one to six carbon atoms in the chain.

The term “alkyl” refers to a straight- or branched-chain monovalent hydrocarbon group. The term “alkylene” refers to a straight- or branched-chain divalent hydrocarbon group. In some embodiments, it can be advantageous to limit the number of atoms in an “alkyl” or “alkylene” to a specific range of atoms, such as C₁-C₆₀ alkyl or C₁-C₆₀ alkylene, C₁-C₃₆ alkyl or C₁-C₃₆ alkylene, C₁-C₁₈ alkyl or C₁-C₁₈ alkylene, or C₁-C₆ alkyl or C₁-C₆ alkylene. Unless otherwise indicated, an alkyl or alkylene group as described herein alone or as part of another group is an optionally substituted linear or branched saturated hydrocarbon chain containing from, for example, one to about sixty carbon atoms, such as one to about thirty-six carbon atoms or one to about eighteen carbon atoms, in the main chain. Examples of alkyl groups include methyl, ethyl, n-propyl, i-propyl, n-butyl, i-butyl, s-butyl, t-butyl, n-pentyl, i-pentyl, s-pentyl, t-pentyl, and the like. Examples of alkylene groups include methylene (—CH₂—), ethylene ((—CH₂—)₂), n-propylene ((—CH₂—)₃), iso-propylene ((—C(H)(CH₃) CH₂—)), n-butylene ((—CH₂—)₄), and the like. An alkyl or alkylene group can be substituted with any of the substituents in the various embodiments described herein, including one or more of such substituents, such as hydroxy groups.

The term “alkenyl” refers to a straight- or branched-chain mono-valent hydrocarbon group having one or more double bonds. In some embodiments, it can be advantageous to limit the number of atoms in an “alkenyl” to a specific range of atoms, such as C₂-C₆₀ alkenyl, C₂-C₃₆ alkenyl, C₂-C₁₈ alkenyl, or C₂-C₆ alkenyl. Unless otherwise indicated, an alkenyl group as described herein alone or as part of another group is an optionally substituted linear or branched hydrocarbon chain containing from, for example, one to about sixty carbon atoms, such as one to about thirty-six carbon atoms or one to about eighteen carbon atoms, in the main chain. Examples of alkenyl groups include ethenyl (or vinyl), allyl, and but-3-en-1-yl. Included within this term are cis and trans isomers and mixtures thereof. A double bond of an alkenyl group may be represented by the structure “=” or “ [symbol] .” It will be appreciated that a double bond represented by the structure “ [symbol] ” may represent an unspecified cis or trans configuration or a mixture of cis and trans configurations. It will be appreciated that an alkenyl can be unsubstituted or substituted as described herein. An alkenyl group can be substituted with any of the substituents in the various embodiments described herein, including one or more of such substituents, such as hydroxy groups.

The term “cycloalkyl” refers to a monovalent cyclic alkyl group containing from, for example, about 3 to about 12 carbon atoms, preferably from about 4 to about 8 carbon atoms, and more preferably from about 4 to about 6 carbon atoms. The term “cycloalkylene” refers to a divalent cyclic alkyl group containing from, for example, about 3 to about 12 carbon atoms, preferably from about 4 to about 8 carbon atoms, and more preferably from about 4 to about 6 carbon atoms. Examples of such cycloalkyl groups include cyclopropyl, cyclobutyl, cyclopentyl, cyclohexyl, cycloheptyl, cyclooctyl, and the like. Examples of such cycloalkylene groups include cyclopropylene, cyclobutylene, cyclopentylene, cyclohexylene, cycloheptylene, cyclooctylene, and the like. A cycloalkyl or cycloalkylene group can be substituted with any of the substituents in the various embodiments described herein, including one or more of such substituents. For example, the cycloalkyl or cycloalkylene groups may be unsubstituted or further substituted with hydroxy groups or alkyl groups, such as methyl groups, ethyl groups, and the like.

The terms “amine” and “amino” are art-recognized and refer to both unsubstituted and substituted amines and salts thereof, e.g., a moiety that can be represented by —NR⁹R¹⁰ or —N⁺R⁹R¹⁰R¹¹, wherein R⁹, R¹⁰, and R¹⁰, each independently represent a hydrogen or a hydrocarbyl group, or R⁹ and R¹⁰ taken together with the N atom to which they are attached complete a heterocycle having from 4 to 8 atoms in the ring structure.

The terms “hydroxy” and “hydroxyl” refer to a group represented by —OH.

The term “aryl” includes monovalent substituted or unsubstituted aromatic groups in which each atom of the ring is carbon. The term “arylene” includes bivalent substituted or unsubstituted aromatic groups in which each atom of the ring is carbon. Preferably the ring is a 5- to 10-membered ring, more preferably a 6-membered or a 10-membered ring. The terms “aryl” and “arylene” also include polycyclic ring systems having two or more cyclic rings in which two or more carbons are common to two adjoining rings wherein at least one of the rings is aromatic, e.g., the other cyclic rings can be cycloalkyls, cycloalkenyls, cycloalkynyls, aryls, heteroaryls, and/or heterocyclyls. The terms “aryl” and “arylene” apply to cyclic groups that are planar and comprise 4n+2 electrons, according to Huckel's Rule. The term “aryl” includes both unsubstituted and substituted aryl groups, the latter of which refers to aryl moieties having substituents replacing a hydrogen.

The term “anhydride” refers to a functional group including two acyl groups bound to oxygen represented by the structure —C(O)OC(O)—.

The term “imide” refers to a functional group including two acyl groups bound to nitrogen represented by the structure —C(O)NRC(O)—.

The term “succinimide” refers to a dicarboximide that is pyrrolidine which is substituted by oxo groups at positions 2 and 5. For example, a succinimide may be represented by the structure

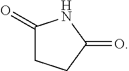

The term “succinimide” includes both unsubstituted and substituted succinimide groups. Illustrative examples of such succinimides include, but are not limited to:

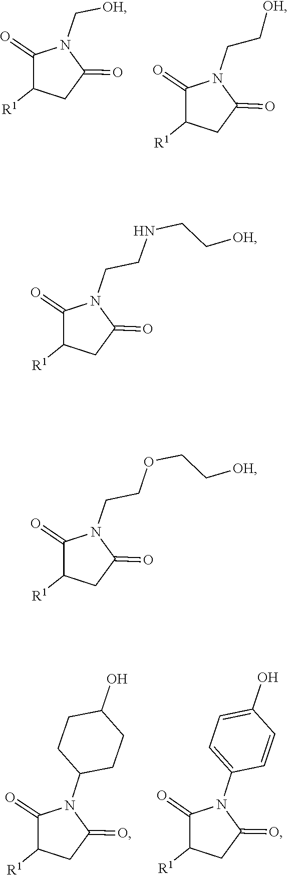

and the like.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include hydroxy, a C₁-C₂₀ alkyl group optionally substituted with a hydroxy, a C₃-C₂₀ cycloalkyl group optionally substituted with a hydroxy, a C₂-C₂₀ alkenyl group optionally substituted with a hydroxy, a C₃-C₂₀ cycloalkenyl group optionally substituted with a hydroxy, or a C₆-C₁₀ aryl group optionally substituted with a hydroxy. Those skilled in the art will appreciate that many substituents can be substituted by additional substituents.

The term “substituted” as in “substituted alkyl,” means that in the group in question (i.e., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino (—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

As used herein, the terms “salt” or “or salt thereof” are used to refer to an acid addition salt or a base addition salt of compounds of present disclosure. The selection of the appropriate salt will be known to a person skilled in the art.

It has been discovered that foams present in industrial media can be controlled using a composition comprising, consisting essentially of, or consisting of an effective amount of a reaction product of an alkenyl succinic anhydride and an amino-hydroxy compound. It has also been discovered that the compositions disclosed herein are effective in reducing foam in industrial media.

In some embodiments, the present disclosure provides methods of controlling foam in an industrial medium. The methods may comprise adding an effective amount of a composition to the industrial medium, the composition comprising a reaction product of a succinic anhydride and an amino-hydroxy compound.

In some embodiments, the succinic anhydride comprises an ASA. In some embodiments, the succinic anhydride is selected from the group consisting of octenyl succinic anhydride, dodecenyl succinic anhydride, undecenyl succinic anhydride, hexadecenyl succinic anhydride, octadecenyl succinic anhydride, and any combination thereof. For example, the succinic anhydride may be dodecenyl succinic anhydride or octadecenyl succinic anhydride.

In some embodiments, the amino-hydroxy compound comprises an acyclic aliphatic compound, a cyclic aliphatic compound, an aromatic compound, or any combination thereof. In some embodiments, the amino-hydroxy compound is an aliphatic compound, such as acyclic aliphatic compound or a cyclic aliphatic compound. The amino-hydroxy compound is not particularly limited and may be selected from any compound including both a primary amino group (i.e., —NH₂) and a hydroxyl group. The amino-hydroxy compound could be any compound that comprises an amino group, such as a primary amino group, and a hydroxy group. For example, the amino-hydroxy compound can be any acylic or cyclic aliphatic amino-hydroxy compound herein or any aromatic amino-hydroxy compound disclosed herein.

In some embodiments, the cyclic aliphatic amino-hydroxy compound is selected from:

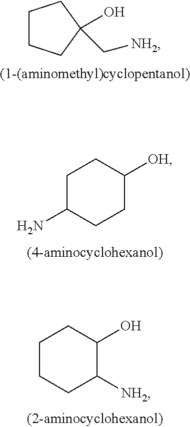 [SMILES: NCC1(O)CCCC1 ; NC1CCC(O)CC1 ; NC1CCCCC1O]

or any combination thereof.

In some embodiments, the acyclic aliphatic amino-hydroxy compound is selected from:

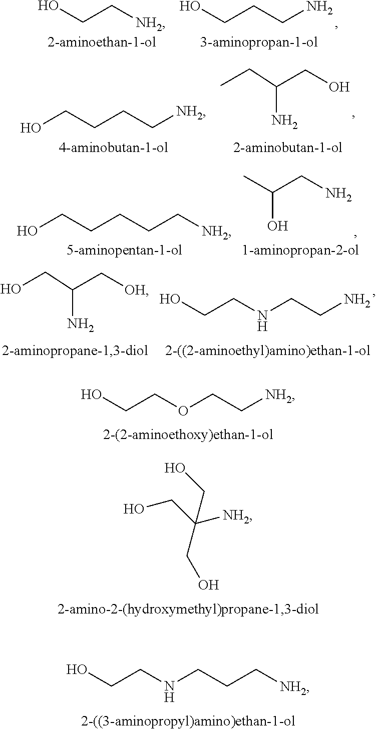

or any combination thereof.

In some embodiments, the aromatic amino-hydroxy compound is selected from:

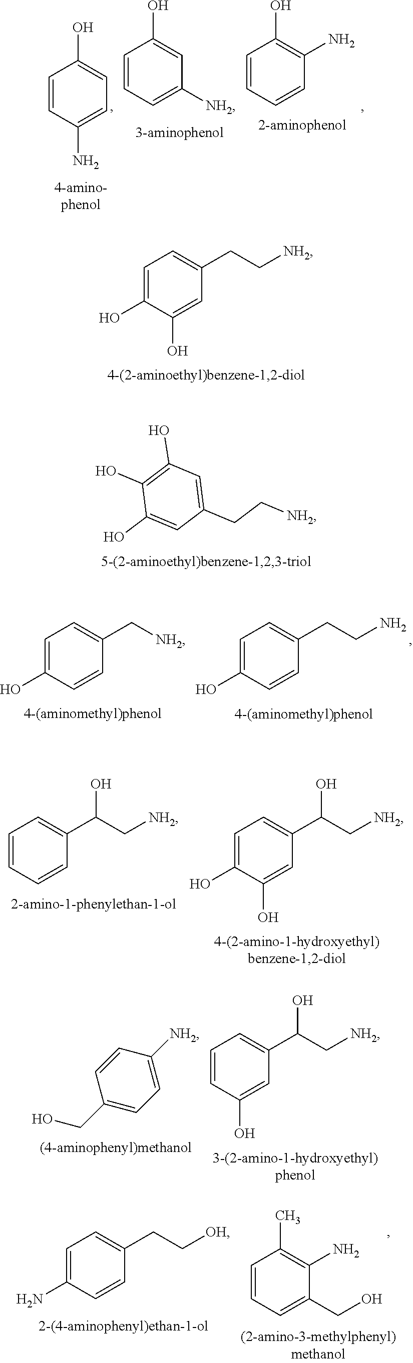

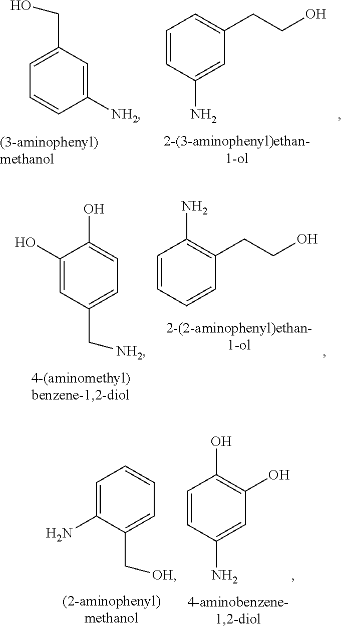

or any combination thereof.

In some embodiments, the amino-hydroxy compound is selected from the group consisting of 1-(aminomethyl)cyclopentanol, 4-aminocyclohexanol, 2-aminocyclohexanol, 2-aminoethanol, 3-aminopropanol, 4-aminobutanol, 2-aminobutanol, 5-aminopentanol, 1-amino-2-propanol, 2-((2-hydroxyethyl)amino) ethanol, 2-aminopropane-1,3-diol, 2-(2-aminoethylamino) ethanol, 2-(2-aminoethoxy) ethanol, 2-amino-2-(hydroxymethyl) propane-1,3-diol, 2-((3-aminopropyl)amino) ethanol, and any combination thereof.

In some embodiments, the reaction product is provided by reacting the succinic anhydride and the amino-hydroxy compound via water molecule elimination. The reaction may be carried out using a molar ratio of primary amine moieties to anhydride moieties of about 5:1 to about 1:5, for example, such as about 4:1 to about 1:4, about 3:1 to about 1:3, about 2:1 to about 1:2, or about 1:1. The reaction may be carried out at temperatures between about 100° C. and about 200° C. For example, the reaction may be carried out at temperatures less than about 200° C., less than about 180° C., between about 100° C. and about 180° C., between about 120° C. and about 180° C., between about 140° C. and about 180° C., between about 160° C. and about 180° C., between about 100° C. and about 160° C., between about 100° C. and about 140° C., and between about 100° C. and about 120° C.

Amino-hydroxy compounds are bifunctional compounds and may react with the succinic anhydride through both the amino- and the hydroxy-functionalities. The amine group is more nucleophilic than the hydroxyl group, will have higher reactivity, and will react more favorably with the anhydride under milder conditions as compared to hydroxy group. In some embodiments, the primary amine group of the amino-hydroxy compound reacts with the succinic anhydride to provide a succinimide functionalized with a hydroxy group. An illustrative, non-limiting example is below.

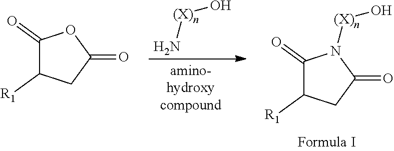

In some embodiments, the reaction product includes a reaction product comprising a succinimide, such as a compound of Formula I, II, or III, and optionally one or more ring-opened products.

Ring-opened products that may be obtained from the reaction of an amino-hydroxy compound and a succinic anhydride include, but are not limited to, an amide-acid structure, an ester-acid structure, an amide-ester structure, an ester-ester structure, and an amide-amide structure. Illustrative, non-limiting examples of ring opened structures is below.

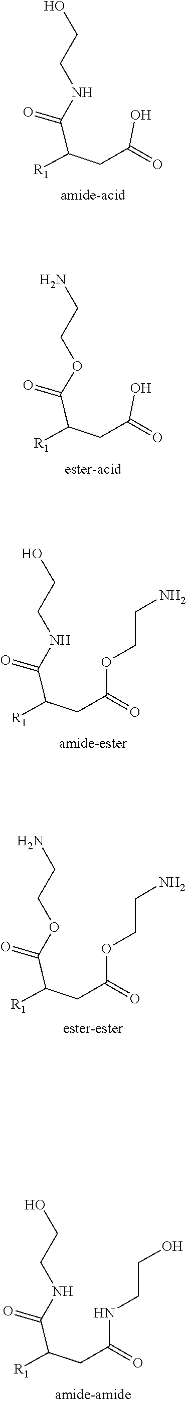

In some embodiments, the reaction product may include greater than about 90 mol % of a succinimide, such as a compound of Formula I, II, or III. For example, the reaction product may include about 90 mol % to about 100 mol %, about 95 mol % to about 100 mol %, about 96 mol % to about 100 mol %, about 97 mol % to about 100 mol %, about 98 mol % to about 100 mol %, or about 99 mol % to about 100 mol % of a succinimide.

Possible ring-opened products that may be obtained from the reaction of the amino-hydroxy compound and the succinic anhydride at about equal molar ratios (e.g., about a 1:1 molar ratio) include amide-acid and ester-acid structures. An illustrative, non-limiting example is below.

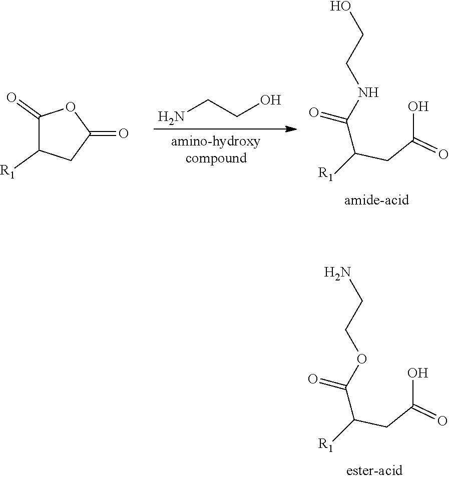

Possible ring-opened products that may be obtained from the reaction of a molar excess of amino-hydroxy compound to the succinic anhydride include amide-ester, ester-ester, and amide-amide structures. An illustrative, non-limiting example is below.

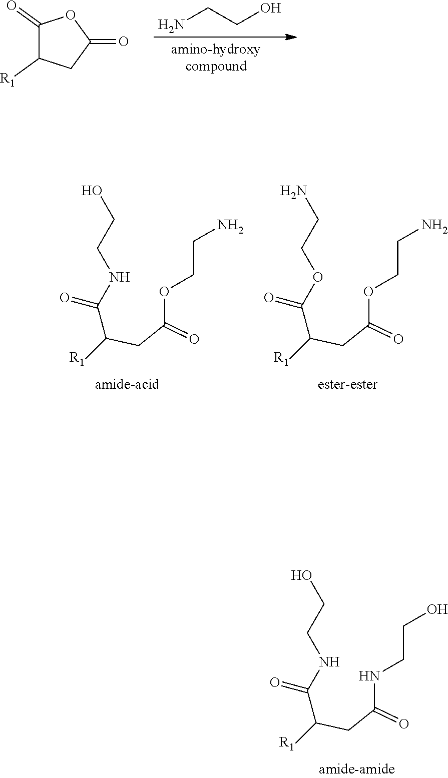

In some embodiments, the reaction product comprises a succinimide, such as a compound of Formula I, II, or III. In some embodiments, the reaction product comprises a hydroxy-succinimide. For example, a hydroxy-succinimide can refer to an N-alkyl succinimide, an N-cycloalkyl succinimide, an N-alkenyl succinimide, an N-cycloalkenyl succinimide, an N-aryl succinimide, where alkyl, cycloalkyl, alkenyl, cycloalkenyl, or aryl are substituted with a hydroxy group.

In certain embodiments, the reaction between a succinic anhydride and an amino-hydroxy compound provides a complete conversion of succinic anhydride starting material to reaction product (e.g., about 97 mol % to about 100 mol %). For example, the reaction product may comprise about 97 mol % to about 100 mol % of succinimide reaction product. In some embodiments, the reaction product excludes an anhydride-containing compound, such as succinic anhydride. For example, the reaction product may exclude succinic anhydride or comprise less than about 3 mol % of a succinic anhydride.

In certain embodiments, the reaction product of the present disclosure includes or excludes a carboxylate-containing compound, such as an amide-acid structure and/or an ester-acid structure. In certain embodiments, the reaction product includes or excludes an amide-containing compound, such as an amide-acid structure, an amide-ester structure, and/or an amide-amide structure. In certain embodiments, the reaction product includes or excludes an ester-containing compound, such as an ester-ester structure, an amide-ester structure, and/or an ester-acid structure.

In some embodiments, the reaction product comprises a structure of Formula I:

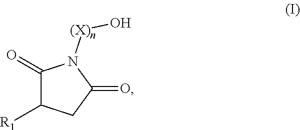

wherein each X is independently selected from a linking group; R₁ is selected from a C₆-C₃₆ alkenyl group, such as a C₉-C₃₆ alkenyl group, a C₁₂-C₃₆ alkenyl group, a C₁₅-C₃₆ alkenyl group, a C₁₈-C₃₆ alkenyl group, a C₂₁-C₃₆ alkenyl group, a C₂₄-C₃₆ alkenyl group, a C₂₇-C₃₆ alkenyl group, a C₃₀-C₃₆ alkenyl group, a C₃₃-C₃₆ alkenyl group, a C₆-C₃₃ alkenyl group, a C₆-C₃₀ alkenyl group, a C₆-C₂₇ alkenyl group, a C₆-C₂₄ alkenyl group, a C₆-C₂₁ alkenyl group, a C₆-C₁₈ alkenyl group, a C₆-C₁₅ alkenyl group, a C₆-C₁₂ alkenyl group, or a C₆-C₉ alkenyl group; and n is 1, 2, 3, or 4.

In some embodiments, the reaction product comprises a structure of Formula II:

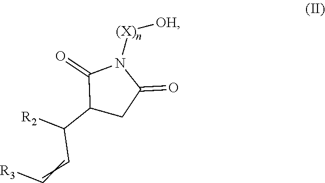

wherein each X is independently selected from a C₁-C₆ alkylene group, such as a C₁-C₄ alkylene group, a C₁-C₂ alkylene group, C₂-C₆ alkylene group, or a C₄-C₆ alkylene group, a C₃-C₁₂ cycloalkylene group, such as a C₆-C₁₂ cycloalkylene group, a C₉-C₁₂ cycloalkylene group, a C₃-C₉ cycloalkylene group, or a C₃-C₆ cycloalkylene group, a C₆-C₁₀ arylene group, such as a C₇, a C₈, or a C₉ arylene group, —O—, —S—, —NH—, or —N(C₁-C₆ alkyl, such as C₁-C₄ alkyl, C₁-C₂ alkyl, C₃-C₆ alky, or C₅-C₆ alkyl)-, provided that (X)ₙ does not comprise an O—O, S—O, O—N—, or N—N bond; R₂ is a C₄-C₁₈ alkyl group, such as a C₇-C₁₈ alky group, a C₁₀-C₁₈ alky group, a C₁₅-C₁₈ alkyl group, a C₄-C₁₅ alkyl group, a C₄-C₁₀ alkyl group, or a C₄-C₇ alkyl group; and R₃ is a C₄-C₁₈ alkyl group, such as a C₇-C₁₈ alkyl group, a C₁₁-C₁₈ alkyl group, a C₁₅-C₁₈ alkyl group, a C₄-C₁₅ alkyl group, a C₄-C₁₀ alkyl group, or a C₄-C₆ alkyl group.

In some embodiments, the reaction product comprises a structure of formula III:

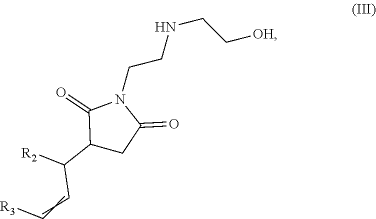

wherein R₂ is a C₄-C₁₀ alkyl group, such as a C₇-C₁₀ alkyl group or a C₄-C₇ alkyl group; and R₃ is a C₄-C₁₂ alkyl group, such as a C₇-C₁₂ alkyl group or a C₄-C₇ alkyl group.

In some embodiments, R₁ is C₆-C₃₆ alkenyl. For example, R₁ may be C₆-C₂₄ alkenyl, C₆-C₂₀ alkenyl, C₆-C₁₈ alkenyl, C₈-C₂₄ alkenyl, C₈-C₂₀ alkenyl, or C₈-C₁₈ alkenyl. In some embodiments, R₁ may be octenyl, dodecenyl, undecenyl, hexadecenyl, or octadecenyl. For example, R₁ may be dodecenyl or i-octadecenyl. In some embodiments, R₁ comprises one degree of unsaturation (e.g., one double bond).

In some embodiments, R₂ is C₄-C₁₈ alkyl. For example, R₂ may be C₄-C₁₆ alkyl, C₄-C₁₄ alkyl, C₄-C₁₂ alkyl, or C₄-C₁₀ alkyl.

In some embodiments, R₃ is C₄-C₁₈ alkyl. For example, R₃ may be C₄-C₁₆ alkyl, C₄-C₁₄ alkyl, C₄-C₁₂ alkyl, or C₄-C₁₀ alkyl.

In some embodiments, each X is independently a linking group selected from the group consisting of C₁-C₆ alkylene, C₃-C₁₂ cycloalkylene, C₆-C₁₀ arylene, —O—, —S—, —NH—, or —N(C₁-C₆ alkyl)-, provided that (X)ₙ does not comprise an O—O, S—O, O—N—, or N—N bond. In some embodiments, each C₁-C₆ alkylene, C₃-C₁₂ cycloalkylene, C₆-C₁₀ arylene, or —N(C₁-C₆ alkyl)- of X is optionally substituted with one or more of —OH. In some embodiments, each X is independently C₁-C₆ alkylene, C₃-C₁₂ cycloalkylene, C₆-C₁₀ arylene, —O—, or —NH—, provided that (X)ₙ does not comprise an O—O, O—N—, or N—N bond.

In some embodiments, (X)ₙ is a linker. As used herein, the term “linker” includes is a chain of atoms that connects two or more functional parts of a molecule. Illustratively, the chain of atoms is selected from C, N, O, and S. The chain of atoms covalently connects different functional capabilities of the reaction product, such as a hydroxy group and succinimide group. The linker may have a wide variety of lengths, such as in the range of about 1 to about 50 atoms in the contiguous backbone. For example, the linker may comprise about 2 to about 36 atoms, about 2 to about 24 atoms, about 2 to about 18 atoms, about 2 to about 12 atoms, or about 2 to about 6 atoms in the contiguous backbone. Illustrative, non-limiting examples of linkers include alkylene, cycloalkylene, and arylene groups. In some embodiments, (X)ₙ is alkylene, cycloalkylene, arylene, alkylene-O-alkylene, alkylene-NH-alkylene, alkylene-cycloalkylene, or alkylene-arylene. In some embodiments, each alkylene, cycloalkylene, or arylene of (X)ₙ is optionally substituted with one or more of —OH.

In some embodiments, (X)ₙ is methylene, ethylene, n-propylene, iso-propylene, cyclopropylene, cyclohexylene, phenylene, methylene-phenylene, ethylene-phenylene, —CH₂CH₂NHCH₂CH₂—, or —CH₂CH₂OCH₂CH₂—. In some embodiments, (X)ₙ is optionally substituted with one or two of —OH.

In some embodiments, n is 1, 2, 3, or 4. For example, n may be 1, 2, or 3, n may be 1 or 2, or n may be 1.

In some embodiments, the composition excludes a silicon-containing compound. In some embodiments, the composition excludes hydrophobic silica, a silicone surfactant, and/or polydimethylsiloxane.

In accordance with certain embodiments of the present disclosure, a composition may comprise a solvent. The solvent may comprise, for example, water, methanol, ethanol, propanol, isopropanol, n-butanol, isobutanol, sec-butanol, tert-butanol, a C₅ to C₁₈ hydrocarbon, or any combination thereof.

If a composition of the present disclosure comprises a solvent, the amount of solvent in the composition is not particularly limited. For example, a composition of the present disclosure may comprise from about 0.1 wt. % to about 99 wt. % of a solvent, such as about 1 wt. % to about 75 wt. %, about 1 wt. % to about 50 wt. %, about 1 wt. % to about 25 wt. %, about 10 wt. % to about 99 wt. %, about 25 wt. % to about 99 wt. %, about 50 wt. % to about 99 wt. %, about 75 wt. % to about 99 wt. %, about 60 wt. % to about 95 wt. %, or about 75 wt. % to about 95 wt. %.

The compositions disclosed herein may include or exclude an additive. For example, the compositions may include or exclude a corrosion inhibitor, a viscosity reducer, a friction reducer, a scale inhibitor, a biocide, an emulsifier, an emulsion breaker, a pH modifier, a surfactant, and/or other chemical treatment additives.

If a composition of the present disclosure comprises an additive, the amount of additive in the composition is not particularly limited. For example, a composition of the present disclosure may comprise from about 0.1 wt. % to about 50 wt. % of an additive, such as about 1 wt. % to about 50 wt. %, about 10 wt. % to about 50 wt. %, about 20 wt. % to about 50 wt. %, about 30 wt. % to about 50 wt. %, about 40 wt. % to about 50 wt. %, about 0.1 wt. % to about 40 wt. %, about 0.1 wt. % to about 30 wt. %, about 0.1 wt. % to about 20 wt. %, or about 0.1 wt. % to about 10 wt. %.

In some embodiments, the composition comprises from about 0.001 wt. % to about 100 wt. % of the reaction product, such as from about 0.001 wt. % to about 75 wt. %, about 0.001 wt. % to about 50 wt. %, about 0.001 wt. % to about 25 wt. %, about 0.001 wt. % to about 10 wt. %, about 0.001 wt. % to about 5 wt. %, about 10 wt. % to about 100 wt. %, about 25 wt. % to about 100 wt. %, about 50 wt. % to about 100 wt. %, or about 75 wt. % to about 100 wt. % of the reaction product. For example, the composition may comprise about 0.5 wt. %, about 0.75 wt. %, about 1 wt. %, about 1.5 wt. %, about 2 wt. %, or about 2.5 wt. % of the reaction product.

In some embodiments, the effective amount of the composition is added to the industrial medium to provide a concentration of about 0.0001 wt. % to about 50 wt. % of the reaction product in the industrial medium. For example, the effective amount of the composition is added to the industrial medium to provide a concentration of about 0.0001 wt. % to about 40 wt. %, about 0.0001 wt. % to about 30 wt. %, about 0.0001 wt. % to about 20 wt. %, about 0.0001 wt. % to about 10 wt. %, about 0.0001 wt. % to about 5 wt. %, about 0.0001 wt. % to about 2.5 wt. %, about 0.0001 wt. % to about 1 wt. %, or about 0.0001 wt. % to about 0.1 wt. % of the reaction product in the industrial medium.

In some embodiments, the effective amount of the composition is added to the industrial medium to provide a concentration of about 1 ppm to about 5,000 ppm of the reaction product (and/or additive) in the industrial medium. For example, the effective amount of the composition is added to the industrial medium to provide a concentration of about 1 ppm to about 3,000 ppm, about 1 ppm to about 1,500 ppm, about 1 ppm to about 750 ppm, about 1 ppm to about 500 ppm, about 1 ppm to about 250 ppm, about 10 ppm to about 1000 ppm, about 10 ppm to about 750 ppm, about 10 ppm to about 500 ppm, about 10 ppm to about 250 ppm, about 100 ppm to about 1000 ppm, about 100 ppm to about 750 ppm, about 100 ppm to about 500 ppm, about 250 ppm to about 1000 ppm, or about 250 ppm to about 750 ppm of the reaction product in the industrial medium.

While carrying out the methods of the present disclosure, the compositions, rection products, and/or additives disclosed herein may be applied to an industrial medium batch-wise, continuously, or semi-continuously.

The compositions, reaction products, and/or additives disclosed herein may be added to a medium using a variety of different application methods known in the art. In some embodiments, the compositions, reaction products, and/or additives may be added continuously or intermittently to the medium, either automatically or manually, by using, for example, chemical injection pumps. The addition may involve dripping, pouring, spraying, pumping, injecting, or otherwise adding the composition, reaction product, and/or additive to the medium.

In some embodiments, the industrial medium is an aqueous medium. In some embodiments, the industrial medium comprises water and/or a brine. In some embodiments, the industrial medium comprises a surfactant, such as a foaming surfactant. In some embodiments, the industrial medium comprises a black liquor.

A medium (e.g., a fluid and/or a gas) treated with a composition, reaction product, etc., of the present disclosure can be at any selected temperature, such as ambient temperature or an elevated temperature. For example, the medium may be at a temperature of from about 40° C. to about 250° C. In some embodiments, the medium may be at a temperature of from about −50° C. to about 300° C., about 0° C. to about 200° C., about 10° C. to about 100° C., or about 20° C. to about 90° C.

An industrial medium treated with a composition according to the present disclosure has a significantly reduced level of foam as compared to an industrial medium that does not comprise a composition of the present disclosure. In some embodiments, the treated industrial medium undergoes a 25% to 100% improvement in foaming compared to the untreated industrial medium, or about 40% to 100%, or about 50% to 100%, or about 60% to 100% improvement in foaming compared to the corresponding untreated industrial medium.

The percent improvement in foaming may be measured as a relative reduction in foam within the treated industrial medium compared to the foam in untreated industrial medium. Foaming may also be measured as a relative decrease in the height or volume of foam in treated industrial medium, relative to the with the corresponding untreated industrial medium.

The foregoing may be better understood by reference to the following examples, which are intended for illustrative purposes and are not intended to limit the scope of the disclosure or its application in any way.

### EXAMPLES

The following is a representative synthetic scheme that was carried out to produce an embodiment of a reaction product of a succinic anhydride and an amino-hydroxy compound:

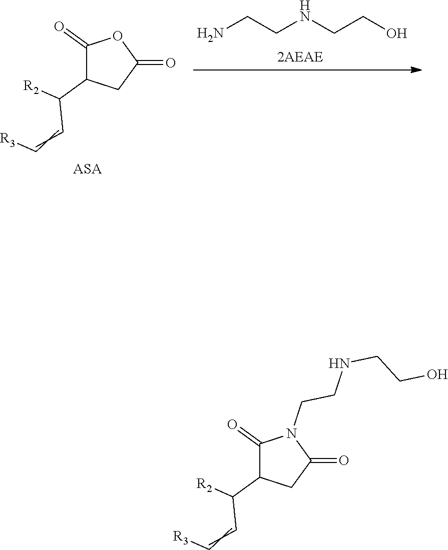

Scheme 1 depicts the synthesis of an imide formed by reaction of an ASA (e.g., i-octadecenyl-succinicanhydride (iODSA) or dodecenylsuccinic anhydride) with 2AEAE. The reaction was carried out at about 160° C., although other temperatures may be utilized, to provide a hydroxy-succinimide structure via water molecule elimination. The resulting chemistry was substantially free of anhydride functionality, as well as amide and carboxylate functionalities. Additionally, about 97 mol %-about 100 mol % of the maleic anhydride groups were reacted with an amino-hydroxy compound to obtain corresponding succinimide groups.

Two compositions were prepared including 1 wt. % of the reaction product provided from the corresponding succinic anhydrides and amino-hydroxy compounds as shown in Table 1.

TABLE 1

| Succinic Anhydride | | |
|---|---|---|
| (ASA) | Amino-hydroxy Compound | Reaction Product |
| i-octadecenyl-succinic | 2-(2-aminoethylamino)ethanol | C₁₈ASA-2AEAE |
| anhydride (iODSA) | (2AEAE) | imide |
| dodecenylsuccinic | 2-(2-aminoethylamino)ethanol | C₁₂ASA-2AEAE |
| anhydride | (2AEAE) | imide |

### Example 1: Antifoam Performance

To illustrate the efficacy of various embodiments of the present disclosure, either an aqueous surfactant solution or black liquor was used as the foaming media. A known amount of the defoamer composition to be tested was introduced into the samples and compared with blank samples.

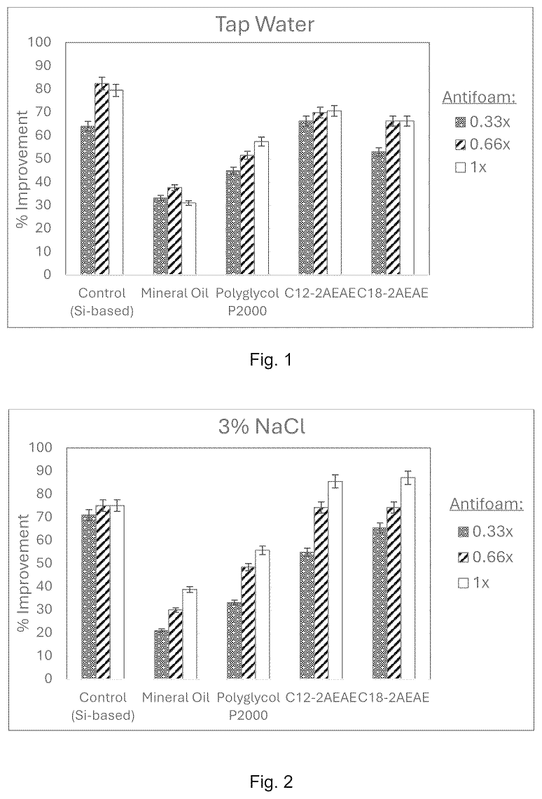

Foam analysis tests were performed in 15 mL centrifuge tubes in triplicates. The tube was filled with 5 mL of the water source (e.g., tap water or 3% NaCl aqueous solution) and dosed with 450 μL of 1 wt. % foaming surfactant (Tergitol 15-S-7). Then, the tube was dosed with 150 μL (0.33×), 300 μL (0.66×), or 450 μL (1×) of 1 wt. % respective antifoam agent. Initial height (hᵢ) of the solution was recorded in mL. The tube was then shaken for 20 seconds and the foam height (h_{f}) in mL was recorded immediately after shaking stopped. The results are shown in FIGS. 1 and 2.

The result is expressed in terms of foam height (h) in mL:

$$h = {h}_{f} - {h}_{i}$$

The blank (Tergitol 15-S-7 only), since no antifoam agent was added, was tested and used to measure the % improvement (foam reduction) by using the following calculation:

$$\% Improvement = \frac{( {h}_{bl ank} - h )}{{h}_{blank}} \times 100$$

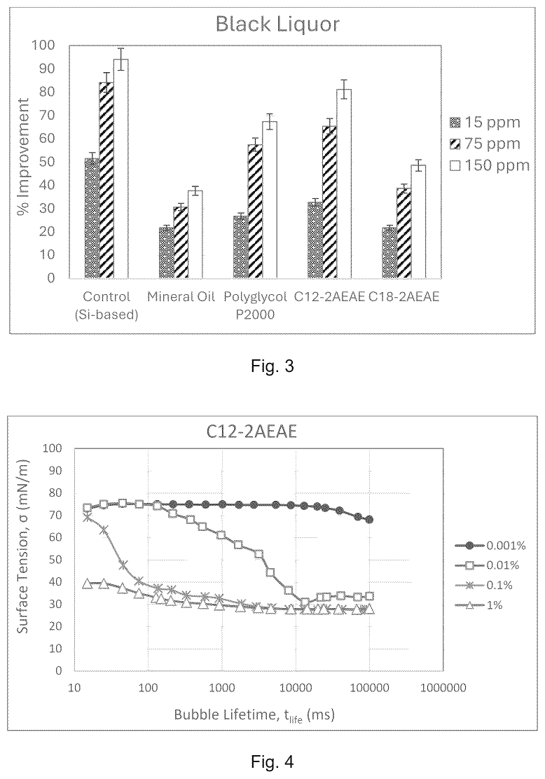

For antifoams tested in black liquor, a similar procedure was followed. Tests were performed in 15 mL centrifuge tubes in triplicates. The tube was filled with 5 mL of 5% black liquor that is heated to 65° C. Since black liquor itself naturally foams, no foaming agent needed to be added. Then, the black liquor was dosed with 7.5 μL (15 ppm), 37.5 μL (75 ppm), and 75 μL (150 ppm) of 1 wt. % respective antifoam agent. Initial height of the solution was recorded. The tube was then shaken for 20 seconds and the foam height was recorded immediately after shaking stopped. The results are shown in FIG. 3.

FIGS. 1-3 show the antifoam performance of the compositions under different conditions. As it is evident from these figures, compositions according to the present invention exhibit improved foam control characteristics when compared to conventional organic treatment programs, and comparable to a silicon-based product, which is labeled as “Control (Si based)” in FIGS. 1-3.

The silicon-based product contained water (about 87 wt. %), poly(dimethylsiloxane) (about 9 wt. %), sorbitan monostearate, hydrated silica, ethoxylated sorbitan monostearate, xanthan gum, benzoic acid, erythorbic acid, and fumed silica.

### Example 2: Surface Tension Data for ASA-2AEAE Imides

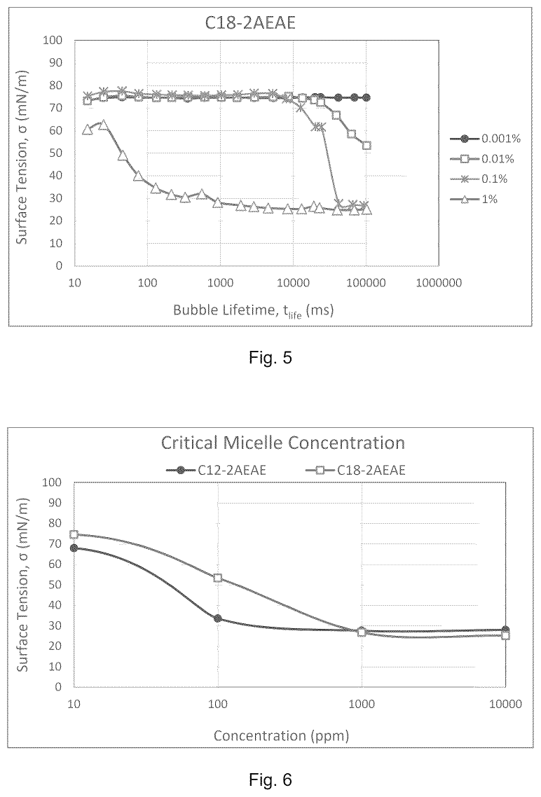

FIGS. 4-7 show the surface tension of two embodiments of the disclosed antifoam agents. The results indicate that both antifoam agents significantly lower the surface tension. These surfactants were measured via a SITA science line t100 bubble tensiometer. The bubble pressure method measures the dynamic surface tension, which is dependent upon the age of the surface. The bubble lifetime (t-life) represents the age of the air-water interface and is defined as the time between pressure minimum and pressure maximum, during which surfactant molecules can attach to the bubble's surface and influence the surface tension reading. Semi-static values are only considered for long bubble lifetimes or in samples with extremely high surfactant concentration. The benefit of dynamic methods is that it can establish a clear correlation between the surfactant concentration and surface tension for concentrations higher than the CMC.

TABLE 2
Summary of surface tension properties
of disclosed antifoam agents in water.

| | Surface Tension, | CMC |
|---|---|---|
| ASA-imide | σ (mN/m) | (ppm) |
| C₁₂ASA-2AEAE imide | 27.2 | ~200 |
| C₁₈ASA-2AEAE imide | 24.8 | ~1000 |

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a reaction product” is intended to include “at least one reaction product” or “one or more reaction products.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, reaction product, component, compound and/or additive disclosed herein or any combination of two or more of the elements, reaction products, components, compounds or additives disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of controlling foam in an industrial medium, comprising:
adding an effective amount of a composition to the industrial medium, the composition comprising a reaction product of a succinic anhydride and an amino-hydroxy compound.

2. The method of claim 1, wherein the succinic anhydride comprises an alkenyl succinic anhydride (ASA).

3. The method of claim 1, wherein the succinic anhydride is selected from the group consisting of octenyl succinic anhydride, dodecenyl succinic anhydride, undecenyl succinic anhydride, hexadecenyl succinic anhydride, octadecenyl succinic anhydride, and any combination thereof.

4. The method of claim 1, wherein the amino-hydroxy compound comprises an acyclic aliphatic compound, a cyclic aliphatic compound, an aromatic compound, or any combination thereof.

5. The method of claim 1, wherein the amino-hydroxy compound is selected from the group consisting of 1-(aminomethyl)cyclopentanol, 4-aminocyclohexanol, 2-aminocyclohexanol, 2-aminoethanol, 3-aminopropanol, 4-aminobutanol, 2-aminobutanol, 5-aminopentanol, 1-amino-2-propanol, 2-((2-hydroxyethyl)amino) ethanol, 2-aminopropane-1,3-diol, 2-(2-aminoethylamino) ethanol, 2-(2-aminoethoxy) ethanol, 2-amino-2-(hydroxymethyl) propane-1,3-diol, 2-((3-aminopropyl)amino) ethanol, and any combination thereof.

6. The method of claim 1, wherein the reaction product comprises a succinimide.

7. The method of claim 1, wherein the reaction product comprises a structure of formula I: 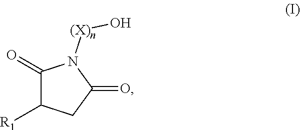
wherein
each X is independently a linking group,
R₁ is C₆-C₃₆ alkenyl, and
n is 1, 2, 3, or 4.

8. The method of claim 1, wherein the reaction product comprises a structure of formula II: 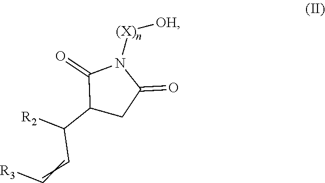
wherein
each X is independently C₁-C₆ alkylene, C₃-C₁₂ cycloalkylene, C₆-C₁₀ arylene, —O—, —S—, —NH—, or —N(C₁-C₆ alkyl)-, provided that (X)ₙ does not comprise an O—O, S—O, O—N—, or N—N bond,
R₂ is C₄-C₁₈ alkyl, and
R₃ is C₄-C₁₈ alkyl.

9. The method of claim 1, wherein the reaction product comprises a structure of formula III: 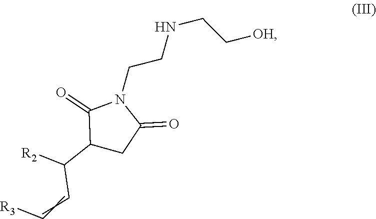
wherein
R₂ is C₄-C₁₀ alkyl, and
R₃ is C₄-C₁₂ alkyl.

10. The method of claim 1, wherein the composition excludes a silicon-containing compound, an anhydride-containing compound, an amide-containing compound, a carboxylate-containing compound, and any combination thereof.

11. The method of claim 1, wherein the method excludes adding a silicon-containing compound, an anhydride-containing compound, an amide-containing compound, a carboxylate-containing compound, and any combination thereof, to the industrial medium.

12. The method of claim 1, wherein the industrial medium comprises water, a surfactant, a black liquor, and/or a brine.

13. The method of claim 1, wherein the industrial medium comprises pulp and paper processing water, wastewater, a laundry detergent, a warewashing detergent, fermentation products, food processing water, petroleum gas scrubbing process water, cleansing or disinfecting water, metal treatment products, polymers, chemical synthesis byproducts, and any combination thereof.

14. The method of claim 1, wherein the effective amount of the composition comprises from about 0.001 wt. % to about 5 wt. % of the reaction product.

15. The method of claim 1, wherein the composition further comprises an additional antifoam agent, an emulsifying surfactant, a solvent, and any combination thereof.

16. A composition, comprising:
an industrial medium and a reaction product of a succinic anhydride and an amino-hydroxy compound.

17. The composition of claim 16, wherein the reaction product comprises a succinimide.

18. The composition of claim 16, wherein the composition excludes a silicon-containing compound, an anhydride-containing compound, an amide-containing compound, a carboxylate-containing compound, and any combination thereof.

19. The composition of claim 16, wherein the industrial medium comprises water, a brine, a surfactant, a black liquor, or any combination thereof.

20. The composition of claim 16, wherein the industrial medium comprises pulp and paper processing water, wastewater, a laundry detergent, a warewashing detergent, fermentation products, food processing water, petroleum gas scrubbing process water, cleansing or disinfecting water, metal treatment products, polymers, chemical synthesis byproducts, and any combination thereof.
